(19) United States
(12) Patent Application Publication
(10) Pub. No.: US 2006/0095853 A1
(43) Pub. Date: May 4, 2006

(54) Event analysis system and method

(76) Inventors: Elise Amyot, Gatineau (CA); Tuan Ho, Ottawa (CA)

Correspondence Address: SHUMAKER & SIEFFERT, P. A., 8425 SEASONS PARKWAY, SUITE 105, ST. PAUL, MN, 55125, US

(21) Appl. No.: 11/042,815

(22) Filed: Jan. 25, 2005

(30) Foreign Application Priority Data
Nov. 1, 2004 (CA) 2,486,482

(51) Int. Cl. G06F 17/00

(52) U.S. Cl. 715/744; 715/738

(57) ABSTRACT

An event analysis system and method of analysing events are provided. The method comprises the steps of displaying event element icons in a user interface, updating the location of moved event element icons in the user interface, and determining an organization of the event elements based upon the location of the event element icons in the user interface. The event element icons represent event elements in an event or chain of event elements. The event element icons are movable in a coding panel of the user interface. The event analysis system comprises a presentation module for generating a user interface and event element icons for the user interface, a controller module for controlling the display of the user interface, and a data model module for holding a data structure representing the event elements and used to generate the event element icons.

### FIELD OF THE INVENTION

The invention relates to an event analysis system and method.

### BACKGROUND OF THE INVENTION

Cause and effect of events can be difficult to determine. Event analysts analyse events elements to try to determine the cause or effect of an event element in a chain of event elements. For example, when tracking a courier package, event elements can include providing a package to a courier company, a courier handling the package, a courier delivering the package to a correct location, a courier delivering the package to an incorrect location, a courier getting into an accident, late delivery, etc. In another example of an event, when attempting to analyse a vehicle or aircraft accident, event elements may include maintenance of the vehicle or aircraft, different operators of the vehicle or aircraft during different legs of a journey, passengers entering or exiting the vehicle or aircraft, vehicle or aircraft component failure, etc. Other examples of events may be conceived, including events in a clinical setting.

Legal actions, complaints and investigations may arise from clinical episodes (or events) due to complications and/or disability associated with the clinical care and medical intervention(s) received by a patient. The episode of clinical care and medical intervention(s) is termed a “clinical chain of event elements” (or a clinical episode). A clinical chain of event elements may comprise several event elements, including presenting conditions, comorbidities, misdiagnoses, interventions, complications, critical incidents, and interventions that were delayed or not performed. Furthermore, several different healthcare providers might be involved in a clinical event.

Typically, a clinical episode analyst would receive and/or store clinical event information in a repository for analysis. The event elements may be coded. The analyst may use a classification system, such as the international classification of disease-version 10-Canada/Canadian classification of health intervention (ICD-10-CA/CCI) coding, to assist with predictive modeling and root-cause analysis to identify high-risk patient and clinical event characteristics in order to prevent high-risk situations from occurring. Clinical event elements may include, a patient having a problem, a doctor performing an action, an action having complications, other doctors becoming involved, etc. It is desirable to organize such clinical event elements for analysis.

In the past, analysts would have to manually organize a chain of event elements. This is problematic since the organization of events for cause-and-effect (or root-cause) analysis can be onerous. Moreover, the organization of event elements may need to be changed, particularly if past event elements are determined and added after later event elements have already been organized. Often, event element information may be received incrementally, thus requiring an amendment to the organization of event elements. Relationships between events can be complicated such that an analyst cannot simply organize the event elements progressively. Another disadvantage with manual ordering is that a medical analyst who understands the ICD-10-CA/CCI coding, or whatever classification system is used, is needed in order to be able to perform the ordering. Another disadvantage is that with a chain of event elements having multiple levels or progressions of care, an analyst can only assume a cause and effect relationship for a first level of event elements.

There are software systems that provide a method and system for processing and presenting online, multimedia information in a tree structure. The method and system can be used for training, process planning, marketing, sales, help desk applications, other machine diagnostics, and engineering design. Such systems use multimedia information tools (i.e., graphics, documentation, drawings, photographs, full motion video with audio, PLC ladder, etc.) and techniques to assist maintenance personnel. Diagnostic development and multimedia information assignment are accomplished through graphical visual programming. The system uses diagnostic trees having multimedia graphic icons that define the diagnostic components. Graphical answers with text can be placed in an object node used to build a decision tree structure. The object nodes (graphical answers) can be linked together. An operator of such software systems is asked a series of questions until he reaches the cause of the problem.

There are also network compatible systems for displaying medical information derived from a plurality of sources. Such systems comprise a user interface apparatus having a communication processor for acquiring patient medical data, a processor for prioritizing acquired patient medical data for display in a desired order and for identifying specific displayed parameters of said data in response to a user selection command, and a display generator for generating a window in response to user activation of a displayed icon. The displayed window automatically includes the identified specific displayed parameters and also includes user entered text messages. A medical analyst may collect stored medical information of a patient and display the information in a table or chart. The medical information is time-stamped and thus can be displayed in chronological order or by medical information type or both. The medical analyst may annotate the medical information displayed.

There is no prior art that can be used by an analyst to analyse a chain of event elements (or events) to visually or graphically determine a root-cause or perform a cause-and-effect analysis. In the art described above, organizations of event elements are linear, and thus, an analyst cannot show an inter-dependence between event elements. Without showing inter-dependence of event elements, an analyst is unable to easily determine which event elements may be related to multiple other event elements. The organization of event elements in any of the above described art is determined once and is not easily altered. Moreover, graphical programming art described above cannot be used to analyze the cause-and-effect of a chain of event elements. There is a need in the art for a better way of performing event analysis of event elements in an event.

### SUMMARY OF THE INVENTION

The invention provides a system and method of allowing a user to visually manipulate event element icons in a graphical user interface. Different event element types are distinguished by different icon shapes and different participants are distinguished by different colours. The manipulated event element icons are then translated into sequences, and sometimes orders, based upon the location of the event element icons in the user interface. The locations of the manipulated event element icons are tracked by the system and used to determine the sequences and orders of event elements used to perform analysis on a chain of event elements (or event). Different types of event element icons may be displayed in different colours, shapes, and other attributes that can be used to visually distinguish one event element icon type from another. Similarly, different participants in events can be distinguished visually in the displayed event element icons.

In accordance with an embodiment of the present invention, there is provided a method of analysing events. The method comprises the steps of displaying event element icons in a user interface, updating the location of moved event element icons in the user interface, and determining an organization of the event elements based upon the location of the event element icons in the user interface. The event element icons represent event elements in an event or chain of event elements. The event element icons are movable in a coding panel of the user interface.

In accordance with another embodiment of the present invention, there is provided an event analysis system for analysing events. The event analysis system comprises a presentation module for generating a user interface and event element icons for the user interface, a controller module for controlling the display of the user interface, and a data model module for holding a data structure representing the event elements and used to generate the event element icons. The event element icons represent event elements in an event or chain of event elements.

In accordance with another embodiment of the present invention, there is provided a computer data signal embodied in a carrier wave and representing sequences of instructions which, when executed by a processor, cause the processor to perform a method of analysing events. The method comprises the steps of displaying event element icons in a user interface, updating the location of moved event element icons in the user interface, and determining an organization of the event elements based upon the location of the event element icons in the user interface. The event element icons represent event elements in an event or chain of event elements. The event element icons are movable in a coding panel of the user interface.

In accordance with another embodiment of the present invention, there is provided a computer-readable medium having computer readable code embodied therein for use in the execution in a computer of a method of analysing events. The method comprises the steps of displaying event element icons in a user interface, updating the location of moved event element icons in the user interface, and determining an organization of the event elements based upon the location of the event element icons in the user interface. The event element icons represent event elements in an event or chain of event elements. The event element icons are movable in a coding panel of the user interface.

In accordance with another embodiment of the present invention, there is provided a computer program product for use in the execution in a computer of an event analysis system for analysing events. The event analysis system comprises a presentation module for generating a user interface and event element icons for the user interface, a controller module for controlling the display of the user interface, and a data model module for holding a data structure representing the event elements and used to generate the event element icons. The event element icons represent event elements in an event or chain of event elements.

The event analysis system is used to bring the following advantages to the analysts who are the target users of the system: more efficient organizing, a more effective quality assessment and continuous quality improvement process, improved error detection, an easier mechanism to transfer knowledge, and a simpler way to present the results of sequencing. Advantageously, the invention allows for the visual organization of event elements in an event that can be used to analyse the event. Moreover, the invention allows for the capture of multiple events by allowing for multiple orders. Patterns can be searched in multiple chains of event elements for more complex analysis. Thus, the event analysis system and method can be used as an educational tool to reduce the chance of negative episodes from re-occurring.

### BRIEF DESCRIPTION OF THE DRAWINGS

FIG. 1 shows an example of a typical system architecture.

FIG. 2 shows an example of an event analysis system for analysing events, in accordance with an embodiment of the present invention.

FIG. 3 shows in a flowchart an example of a method of analysing events, in accordance with an embodiment of the event analysis system.

FIG. 4 shows an example of a layout of a presentation module, in accordance with the event analysis system.

FIG. 5 shows an example of an event element item data structure, in accordance with an embodiment of the event analysis system.

FIG. 6 shows the example of an event element item data structure in more detail.

FIG. 7 shows in a flowchart another example of a method of event analysis, in accordance with the event analysis system.

FIG. 8 shows in a flowchart an example of a method of populating an event analysis system UI with event element data, in accordance with an embodiment of the event analysis system.

FIG. 9 shows in a flowchart an example of a method of translating event element icons into event element data, in accordance with an embodiment of the event analysis system.

FIG. 10 shows an example of an event analysis system software architecture, in accordance with an embodiment of the event analysis system.

FIG. 11 shows in a flowchart one example of a method of event element pattern recognition, in accordance with an embodiment of the event analysis system.

FIG. 12 shows examples of symbols associated with clinical event elements, in accordance with an embodiment of the event analysis system.

FIG. 13 shows an example of a medical information table of a customer resource management application, in accordance with an embodiment of the event analysis system.

FIGS. 14 to 16 show in screenshots examples of a user interface of the event analysis system.

FIG. 17 shows another example of the medical information table of the customer resource management application expanded to show sequence information translated from the event element icons of the event analysis system.

FIG. 18 shows in a screenshot an example of a display of exported sequence analysis information, in accordance with an embodiment of the event analysis system.

FIG. 19 shows in a screenshot an example of an event with two orders, in accordance with an embodiment of the event analysis system.

### DETAILED DESCRIPTION OF THE PREFERRED EMBODIMENTS

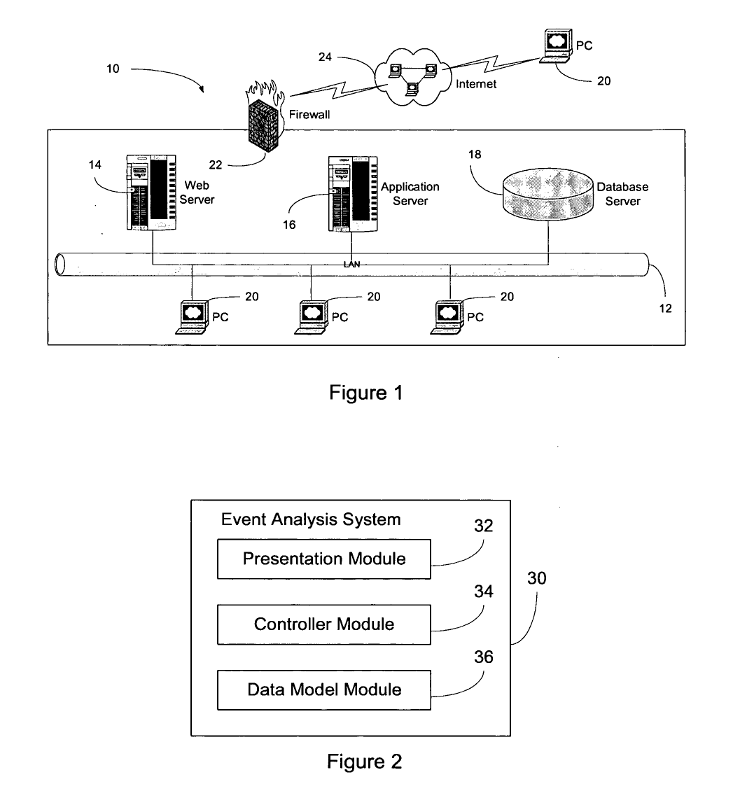

FIG. 1 shows an example of a typical system architecture 10, used in accordance with an embodiment of the present invention. The system architecture 10 comprises a local area network (LAN) 12, a web server 14, an application server 16, a database server 18, one or more workstations or PCs 20, and a firewall 22. The LAN 12 is also connected to an external network 24, such as the Internet, with protection provided by the firewall 22. The firewall 22 acts as a gatekeeper for all incoming and outgoing traffic. A user may access the web server 14 on the LAN 12 using a PC 20 connected to the LAN 12 or to an external network 24. One skilled in the art will appreciate alternative implementations, including software components implemented without networks on a stand-alone machine.

FIG. 2 shows an example of an event analysis system 30 for analysing events, in accordance with an embodiment of the present invention. The event analysis system 30 comprises a presentation module 32 for generating a user interface and event element icons (i.e., graphical elements representing event elements in an event) for the user interface (UI), a controller module 34 for controlling the display of the UI and updating a data structure representing the event elements, and a data model module 36 for holding and updating the data structure used to generate the event element icons. Event element icons are symbols that are displayed visually on the UI and are mapped to event elements in an event. The controller module 34 handles user actions and translates the user actions into commands for the data model module 36. Other components may be added to the event analysis system 30, and the event analysis system 30 may be implemented in system architecture 10.

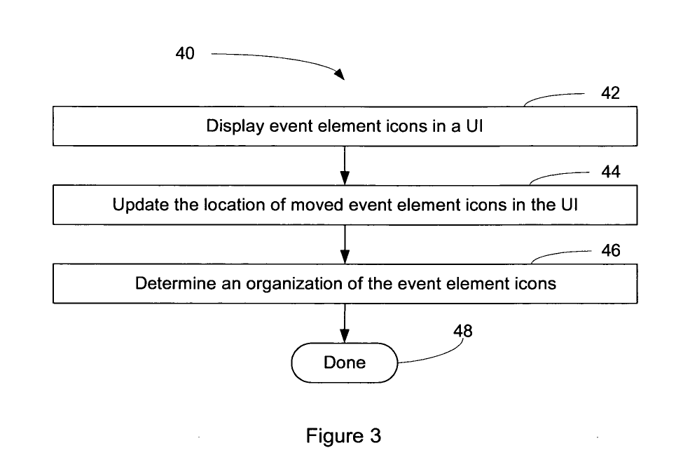

FIG. 3 shows in a flowchart an example of a method of event analysis (40), in accordance with the event analysis system 30. Different types of events have different types of event element icons. The method begins with the step of displaying event element icons in a UI (42). The event element icons are moveable in a coding panel of the UI. Different event element icons may comprise different distinguishing visual features. Examples of distinguishing visual features are further described below. Next, the display and location of moved event element icons in the UI is updated (44). Once the location of the moved event element icons is updated (44), an organization of the event element icons is determined (46) based upon the location of the event element icons in the UI. Once the organisation is determined (46), the method (40) is done (48).

As described below, other steps may be added to the method (40), including determining sequences and orders of the event element icons based upon the location of the event element icons in the UI. A sequence is identified by a number and represents the progression of interactions by participants in the event episode. An event element icon represents the interaction by a participant. An order is identified by a number and indicates a different event. Different events may follow from the same event element. For example, a skier who falls and breaks an arm and a leg can be classified as having two orders, one for the broken arm and the other for the broken leg. Each injury and their medical treatments may considered as separate events. Sequences are assigned to event element icons within an order to indicate an action in the event. Multiple sequences indicate the succession of actions for the one event. Multiple orders indicates multiple events. Sequences and orders are further described below.

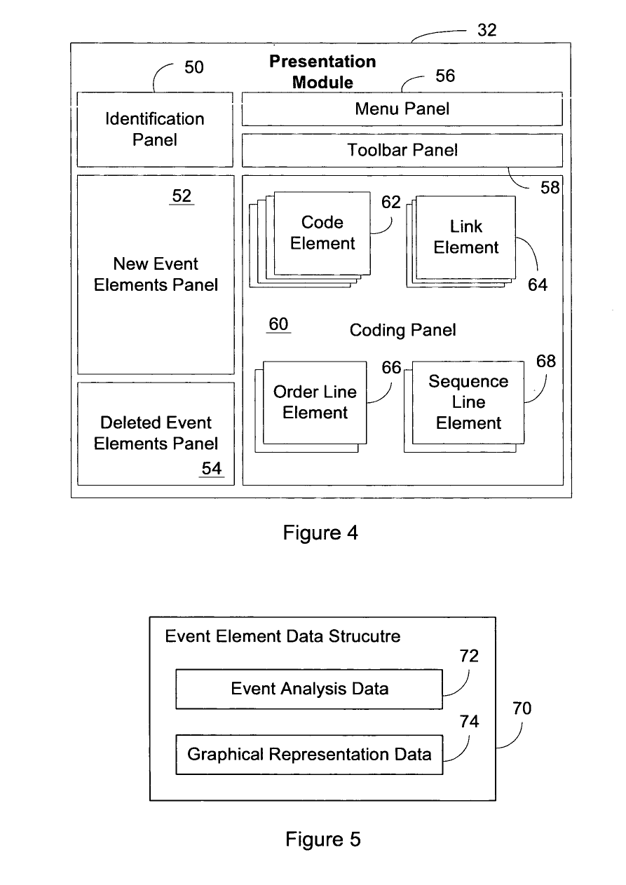

FIG. 4 shows an example of a layout of a presentation module 32, in accordance with the event analysis system 30. The presentation module 32 comprises an identification panel 50 for displaying identification information of an event or multiple events, a new event elements panel 52 for storing event element information retrieved from a database or repository, a deleted event elements panel 54 for storing event element icons to be deleted from the new event elements panel 52 or the coding panel 60, a menu panel 56 for providing menu options, a toolbar panel 58 for providing toolbar options, and a coding panel 60 for displaying graphical representation of the event elements in the form of event element icons 62. The coding panel 60 is a working area for moving event element icons 62 and preferably comprises one or more order line elements 66 for graphically representing order boundaries, and one or more sequence line elements 68 for graphically representing sequence boundaries. Order boundaries and sequence boundaries are further described below. One or more event element icons 62 on the coding panel 60 may be linked. One or more link elements 64 may be added to the coding panel to graphically represent links between event element icons 62. The coding panel 60 and its components are further described below.

The coding panel 60 is a working area for an event analyst to organize event element icons in an event or multiple events. The coding panel 60 is a grid having horizontal and vertical coordinates. The coding panel 60 displays the event element icons 62 that are organized and their relationships. Event element icons can be clicked and dragged from the any panel to the any other panel.

Participants in events may be represented as individuals or in a group. Preferably, event element icons 62 for different groups are represented in different colours. In one example of an embodiment of the event analysis system 30, event element icons 62 for involved parties are displayed in a different colour for each involved party, while all event element icons 62 for other parties are displayed in the same colour, different from the colour of any of the involved parties. Furthermore, event element icons 62 may have different shapes for different types of event elements represented by the event element icon 62. Participants may be part of different classes or memberships of participants. Different colours, or secondary colours, may be added to distinguish different memberships. Tertiary colour markings may also be added to an other party event element icon 62 to indicate an association with an involved party.

A sequence for event data is represented as a vertical range of the overall grid of the coding panel 62. Sequence line elements 68 may be added to, removed from, and moved in the grid. As a sequence line is moved, it changes the active area of the grid that is included or excluded from that sequence, depending on the direction of the movement. The sequence of an event element icon element can be determined by the sequencing range it falls under. When a sequence is expanded, all items that are below that sequence line are shifted downward. When a sequence is shortened, the opposite occurs.

Sequences are assigned to event element icons 62 within an order to indicate an action in the event. An order can also be defined as a group of event element types that when looked at statistically, can represent their own event or chain of event elements. An order for data is represented as a horizontal range of the overall grid. Order line elements 66 may be added to, removed from, and moved in the grid. As an order line is moved, it changes the active area of the grid that is included or excluded from that order, depending on the direction of the movement. The order of an event element icon 62 can be determined by what order range it falls under. When an order is expanded, all items that are to the right of that order line are shifted to the right. When an order is shortened, the opposite occurs.

When there are multiple event element icons 62 for a type of event element and it is desirable to indicate that one or more of the multiple event element icons 62 are associated with another event element type, the relationship is represented by an event element link. Preferably, an event element link is graphically represented within the grid as a line having an arrow between two related event element icons 62. An event element link (or linkage) is a value that represents a relationship between two event element icons 62 that is not apparent. For each event element link applied, the value of the event element link is incremented. Preferably, the numbering of event element link values starts at one, and for each additional event element link, the value is sequentially increased. If an event element link is deleted, the values of all other event element links are modified such that the numbering is sequential. Event element links may be across sequences. Not all event element icons 62 require an event element link.

Event element icons 62 may be grouped together. If two or more event element icons 62 are read together for full specificity, these event element icons 62 are call subcomponents. Subcomponents are given a numerical indicator. Visually, grouped event element icons are represented as one event element icon 62 with a larger shape than a single event element icon.

Event element icons 62 may also be grouped by adding one event element icon 62 inside another. When an event element icon 62 is added to a target event element icon 62, the target event element icon 62 becomes the “parent icon”. Each parent icon is assigned a unique subcomponent value. The “child icons” receive the same sequence, order, suborder, subcomponent, and event element links, as the parent icon. Preferably, a parent icon is larger in size than a single event element icon.

FIG. 5 shows an example of an event element data structure 70, in accordance with an embodiment of the event analysis system 30. The event element data structure 70 comprises event analysis data 72 and graphical representation data 74. The event analysis data 72 is mapped to the graphical representation data 74. The event analysis data 72 is in a form corresponding to data in a table in a database or repository. The graphical representation data 74 includes further information for displaying an event element icon 62 in the user interface.

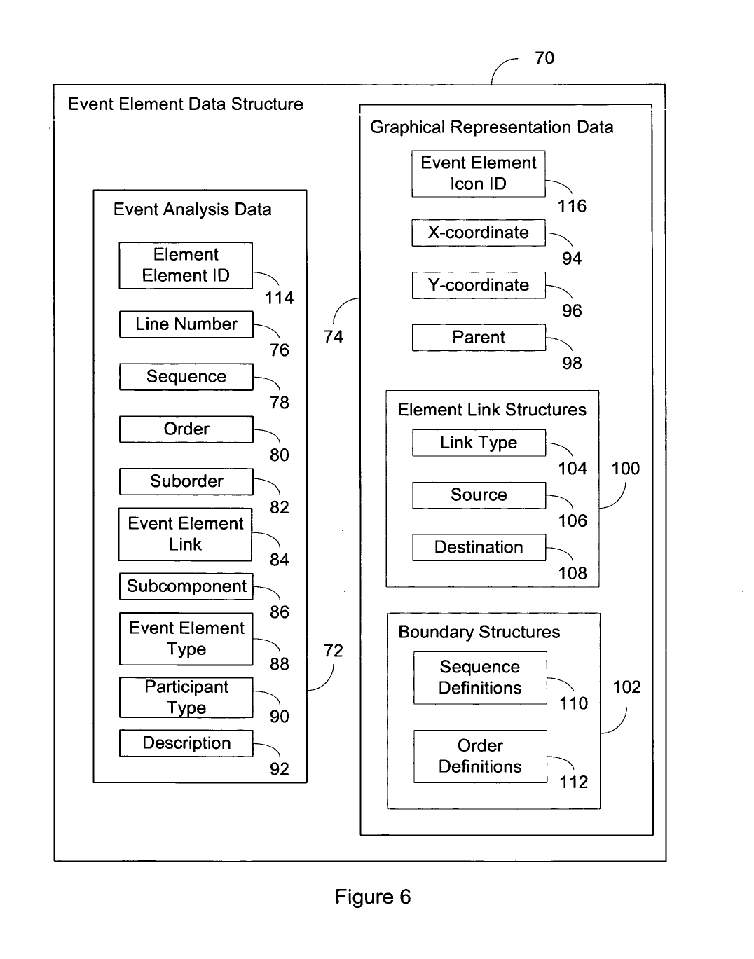

FIG. 6 shows an example of the event element data structure 70 in more detail. The event analysis data components include an event element identifier 114, line number 76, a sequence 78, an order 80, a suborder 82, a event element link 84, a subcomponent 86, an event element type 88, a participant type 90, and a description 92. The graphical representation data components include an event element icon identifier 116, an x-coordinate attribute 94, a y-coordinate attribute 96, a parent attribute 98 for representing a subcomponent relationship between event element icons 62, event element link structures 100 for graphically representing a link between event element icons 62, and boundary structures 102 for graphically representing sequence and order lines in a grid of the coding panel 60. Preferably, the graphical representation of the link structure is an arrow. An event element link structure 100 includes a link type 104 for defining the type of linkage used between two event element icons 62, a link source 106 for denoting the source event element icon 62 that contains the event element link structure 100, and a link destination 108 for denoting the destination event element icon 62 to which the event element link structure 100 connects the source event element icon 62. Preferably, the graphical representation of a boundary structure includes vertical lines defined by an x-coordinate and horizontal lines defined by a y-coordinate. The boundary structure 102 includes sequence definitions 110 and order definitions 112.

Examples of components and attributes of the event element icons 62 in a clinical setting include:

Unique Icon ID

When new event element icons 62 are loaded into the UI for the first time they are assigned a unique name or identifier 116 that identifies them. The unique icon identifier 116 ensures that when relationships are created between shapes it can be validated at a later date to ensure that the source and destination event element icons still exist.

For example, if a user draws an arrow or creates an event element link between ‘event element icon A’ and ‘event element icon C’ on day one, the unique name to an event element icon ensures that if, on day two, ‘event element icon C’ is deleted from the database file, then when the event analysis system 30 is reopened, ‘event element icon A’ knows that ‘event element icon C’ is deleted, and will not attempt to draw a link to it.

Furthermore, a unique name per event element icon prevents another event element icon from taking the old name, and existing relationships within the event analysis system 30, of a deleted icon 62.

X and Y Coordinates 94, 96

Items in the event analysis system 30 are positioned and validated on a global grid that dictates the sequencing and positioning of a shape. Shapes and elements in the event analysis system 30 is in relation to (0,0) on the X, Y axis of the master (or global) grid. Preferably, each cell of the grid is represented by 100 pixels height, and 100 pixels width.

Sequence 78

The sequence 78 is identified by a number and approximates the chronological progression of care. If for example two involved parties operated on a patient at the same time, their care would each be given the Sequence of 1. If Involved Party A cared for a patient first and another Involved party, Involved Party B provided care for the same patient later, Involved Party A's clinical event care would be assigned Sequence 1 and Involved Party B's care would be assigned Sequence 2.

A sequence 78 for data in the event analysis system 30 is represented as a vertical range of the overall grid. As a sequence line 68 is moved, it changes the active area of the grid that is included or excluded from that sequence, depending on the direction of the movement. Thus, the sequence 78 of a shape can be determined by what sequencing range it falls under. When a sequence 78 is expanded, all items that are below that sequence line are shifted, preferably 100 pixels, downward for every cell that the sequence 78 is moved. When a sequence is shortened, the opposite occurs.

Order 80

The order 80 is assigned to event element icons 62 within a sequence 78 to indicate the relationship between the event element types. If a Presenting Condition, a Misdiagnosis and an Intervention are linked, the order 80 is the same for each event element type to indicate this relationship.

An order 80 for data in the event analysis system 30 is represented as a horizontal range of the overall grid. As an order line 66 is moved, it changes the active area of the grid that is included or excluded from that order, depending on the direction of the movement. Thus, the order 80 of a shape can be determined by what order range it falls under. When an order 80 is expanded, all items that are to the right of that order line are shifted, preferably 100 pixels, to the right for every column that the order 80 is moved. When an order 80 is shortened, the opposite occurs.

Suborder 82

The suborder 82 indicates the event element types belong to the same order 80 but have differing linkages. In some instances, several Interventions may be required for one Presenting Condition. The two Intervention icons are given different suborder 82 values.

Suborder 82 is determined by the count of event element icons 62 within a row in the grid. An event element icon 62 that is alone in a row of the grid within a sequence 88 is assigned a value of zero (0). If there are two event element icons 62 in a row of the grid within a sequence 88, the event element icon 62 farthest to the left will be assigned the value one (1) and will increment for each sequential event element icon 62 (i.e., 2, 3, 4, 5) until the next row of the grid is reached.

Event Element Link 84

When there are multiple event element icons 62 for an event element type and it is necessary to indicate that one or several of these event element icons 62 within the event element type are associated with another event element type, the relationship is represented by an event element link 84. For example, a misdiagnosis icon may have a link with only one of several depicted presenting conditions. If an analyst determines that only one presenting condition has been misdiagnosed, only one event element link 84 is created.

An event element link 84 is a value within the event analysis system 30 that represents a relationship of between two event element icons 62 that is not apparent. For each event element link 84 applied in the event analysis system 30 the value of the event element link 84 is incremented. The numbering of event element links 84 start at one (1), for each additional event element link 84 in the event analysis system 30, the value is increased. If an event element link 84 is deleted, the numbering of all other event element links 84 are modified, such that the numbering is sequential. The event element links 84 will be indicated to the user by lines that are visible between the two related event element icons 62. The event element link 84 attribute of a source event element icon has a matching event element link value with the corresponding destination event element icon.

Subcomponent 86

If two or more icons must be read together for full specificity (e.g., 2 diagnostic icons or 2 complication icons), these icons are called subcomponents 86. Parent event element icons and their children event element icons have the same subcomponent value, e.g., 1. The next group of subcomponent 86 has the next incremental subcomponent value, e.g., 2. If full specificity is obtained with only one event element icon 62, the subcomponent value is 0. The children event element icons receive the same sequence 78, order 80, suborder 82, event element link 84 and subcomponent 86 as the parent event element icon. Visually to the user, the combined event element icons ‘appear’ as one, however they are in fact separate, as each on of these event elements remain individual to fit into the data model of the medical information table. When an event element icon 62 is removed from its master, it assumes a subcomponent 86 of zero (0).

Event Element Links 100

Event element links 100 within the event analysis system 30 are used as a visual representation to the user in special cases where a relationship is not evident or implied. The user is able to draw event element links 100 (or lines or arrows) horizontally, vertically or diagonally. The user is able to control the source 106 and destination 108 of the event element links 100. The event element links 100 themselves are automatically generated. Since the event element links 100 are based upon a ‘relationship’ between two event elements, if one of the event elements in the relationship is deleted, the relationship is removed.

Event Element Type 88

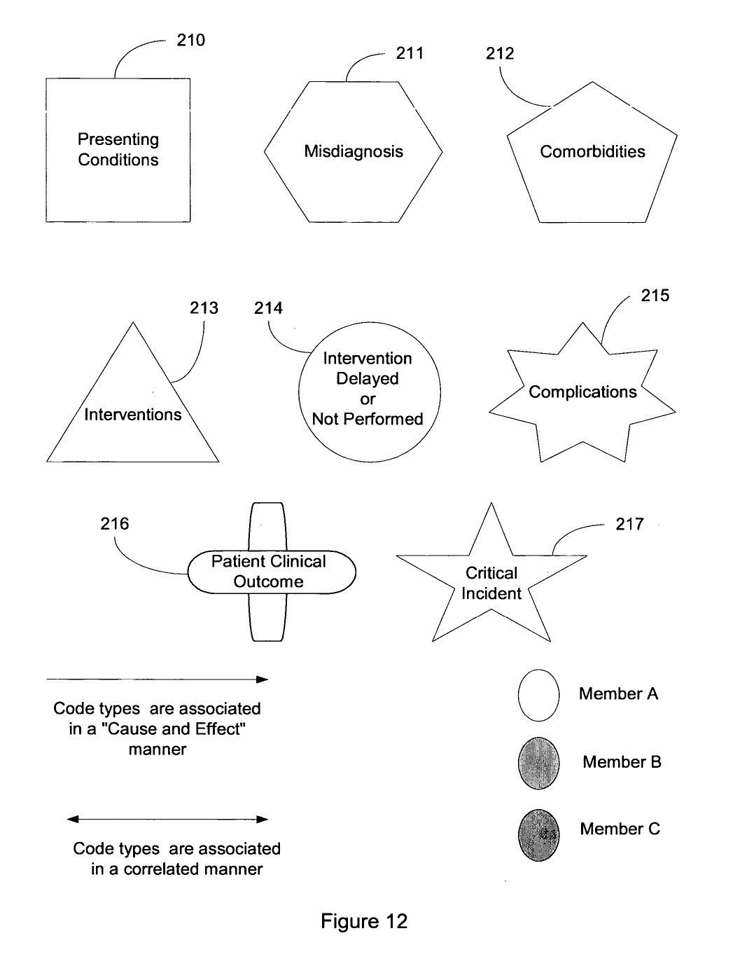

Preferably, the Event Element Type 88 is set in by the user in a medical information table. An example of a medical information table is described below. The user has the option in the event analysis system 30 to change an event element type 88 in the event analysis system 30. The event element type 88 is switched by selecting a new shape from the toolbar 58. In this example, there are eight different event element types 88, each with a distinct shape. A change to an event element type 88 does not affect any other value. Examples of different shapes are shown in FIG. 12.

In one embodiment of the event analysis system 30, the controller module 34 controls the user actions in the UI and translates the user actions into commands for the data model module 36 or the presentation module 32. Although the presentation module 32 and data model module 36 have their own components with functions, the controller module 34 controls the logic that instructs the components of the presentation module 32 and data model module 36 to perform their functions.

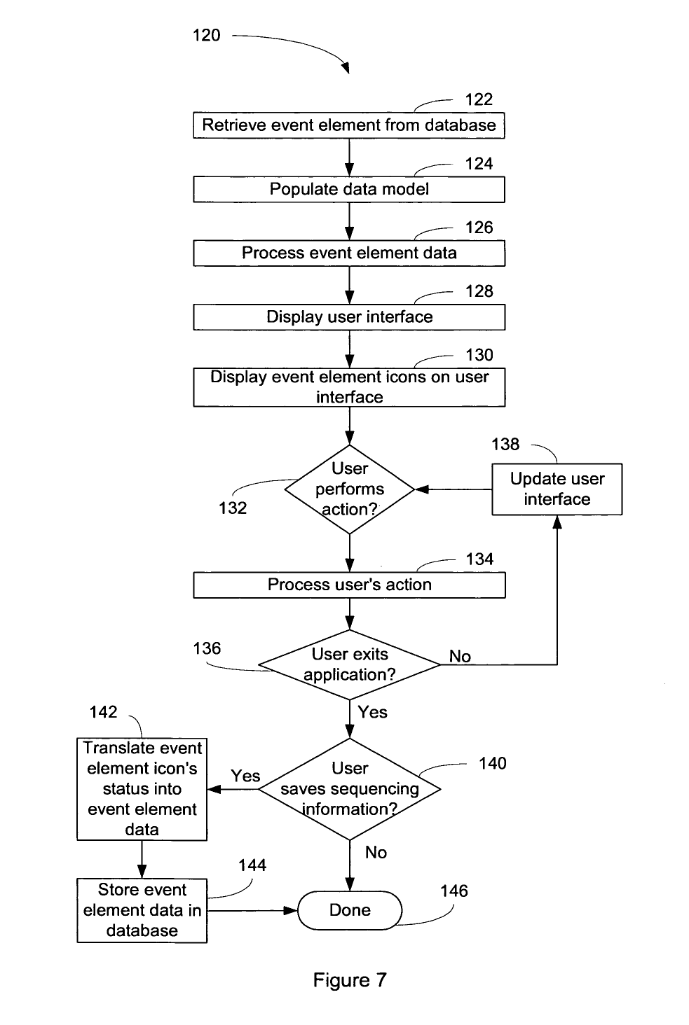

FIG. 7 shows in a flowchart another example of a method of event analysis (120), in accordance with the event analysis system 30. The method begins with the step of retrieving event element data from a repository or database (122). Next, a data model is populated (124). Event element data is then processed (126), and a UI is displayed (128). Once the UI is displayed (128), event element icons 62 are displayed on the UI (130). Steps 122 to 130 are further described below.

The event analysis system 30 then waits for a user action. User actions include adding, deleting, modifying and moving an event element icon 62. A user may also add, delete or modify relationships between the event element icons 62. Other types of user actions may also be performed. The user actions cause changes to the event element icons 62, including changes to the location of the event element icons 62 in the UI.

If a user performs an action (132), then the user's action is processed (134). If the user does not exit the application (136), then the UI is updated (138) and the system waits for another user action (132). If the user does select to exit the application (136), and if the user selects to save the changes to the event element icons 62 (140), then the status of the event element icons 62 are translated into event element data (142) and stored in the database (144). The steps of translating (142) and storing (144) will be further described below. Once the translated event element data is stored (146), or if the user chose not to save the changes to the event element icons 62 (140), the method (120) is done (146).

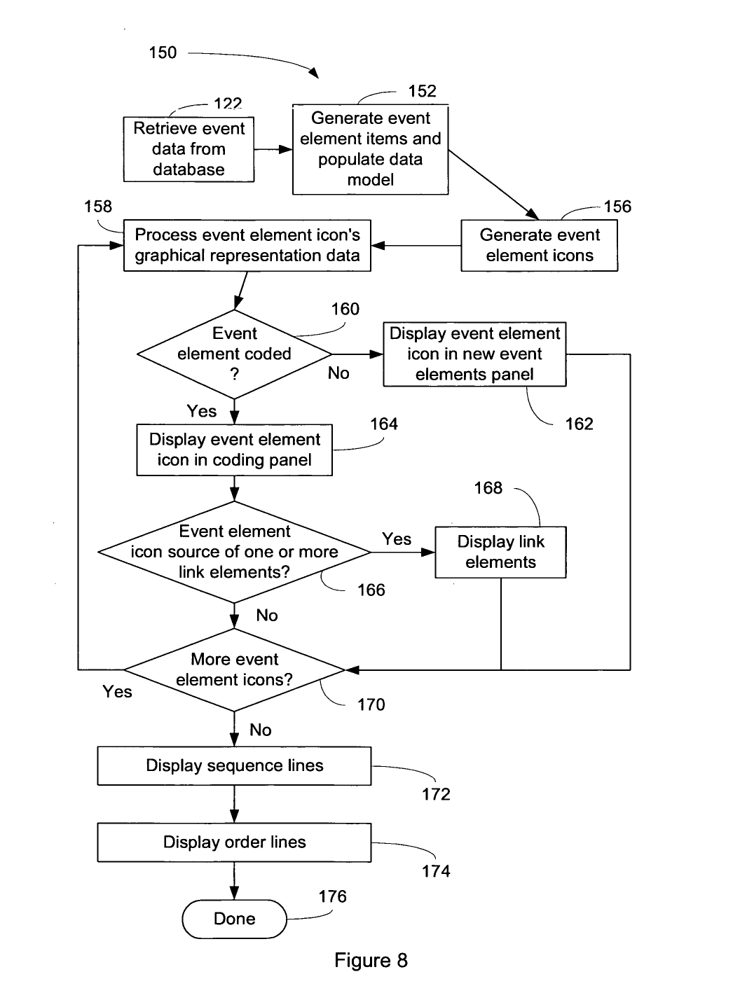

FIG. 8 shows in a flowchart an example of a method of populating an event analysis system UI with event element data (150), in accordance with an embodiment of the event analysis system 30. The method begins with retrieving event element data from a database (122). Next, event element items are generated and the data model is populated (152). Event element items are alphanumeric values that may in turn be mapped to event element icons 62. Next, event element icons 62 are generated (156), and their graphical representation data 74 is processed (158). If the event element icon 62 has not been coded (160) (i.e., if the event element icon 62 does not have values for its attributes used to display the event element icon 62 in the coding panel 60), then the event element icon 62 is displayed in the new event elements panel 52 (162). Otherwise (160), the event element icon 62 is displayed in the coding panel 60 (164). If the event element icon 62 is the source of one or more link elements 64 (166), then the link elements 64 are displayed (168). Otherwise (166), or after steps (162) or (168) are performed, then if there are more event element icons 62 to process (170), then steps (158) to (168) are repeated. Otherwise (170), the sequence lines 68 are displayed (172) and the order lines 66 are displayed (174). The method (150) is done (176). Other steps may be added to the method (150), including the step of generating a document used to store event element items. Preferably, the document is an extensible markup language (XML) document as XML enables flexible data transfer between different components of the event analysis system 30.

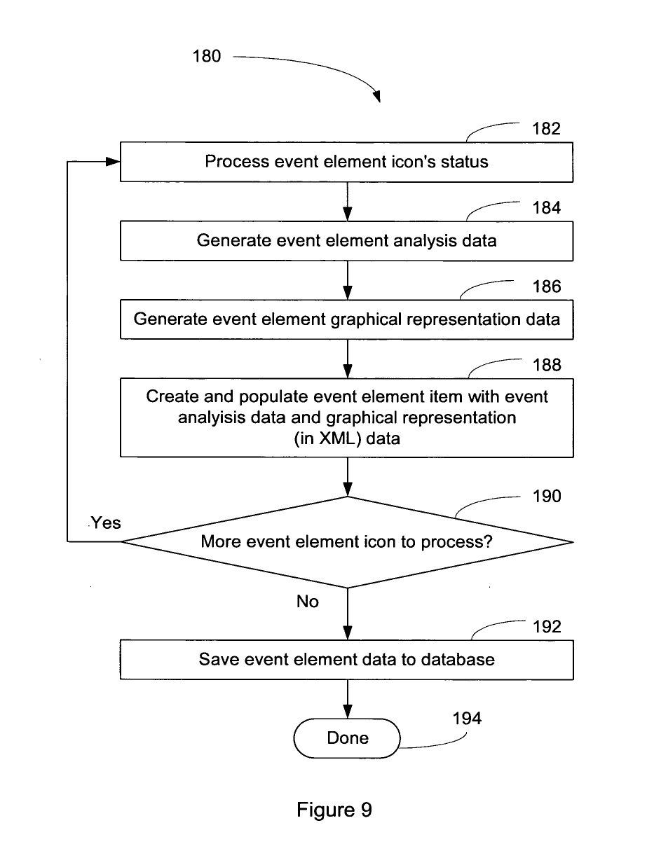

FIG. 9 shows in a flowchart an example of a method of translating event element icons 62 into event element data (180), in accordance with an example of the event analysis system 30. The method begins with processing the status of an event element icon 62 (182) (i.e., its location and relationships in the grid). Next, corresponding event element analysis data 72 is generated (184) and corresponding event element graphical representation data 74 is generated (186). Next, an event element item corresponding to the event element icon 62 is generated and populated with the event analysis data 72 and the graphical representation data 74 (188). If there are more event element icons to process (190), then steps (182) to (188) are repeated. Otherwise (190), the event element data is saved to the database (192). The method (180) is done (194).

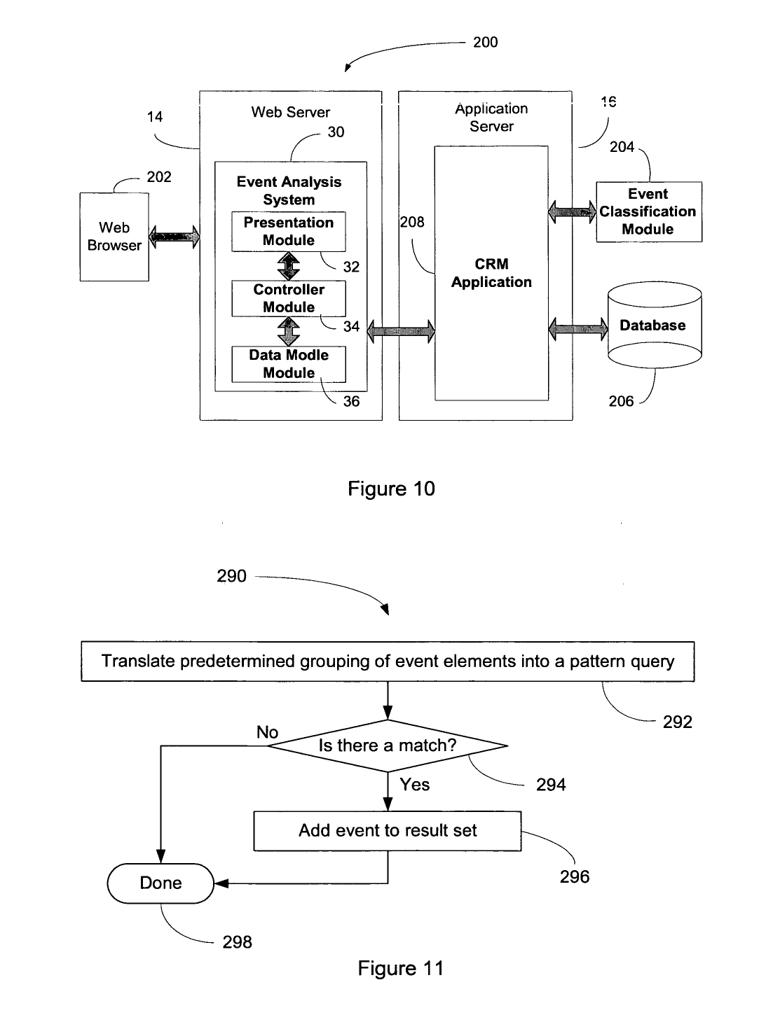

FIG. 10 shows an example of the event analysis system software architecture 200, in accordance with an embodiment of the event analysis system 30. The event analysis system software architecture 200 comprises a web browser 202 application for displaying web pages or web-based user interfaces, a web server 14 for hosting web pages or web page applications, an application server 16 for hosting transaction-based applications, an event classification module 204 for mapping an event element to an event element identifier 114, and a repository or database 206. The web server 14 includes the event analysis system 30 having the presentation module 32, controller module 34 and the data module 36. The application server 16 includes a customer resource management (CRM) application 208. A commercially available CRM application may be used. The web browser 202 application exchanges requests and responses with the web server 14 hosting the event analysis system 30 for displaying and updating the event analysis system's user interface in the web browser application. Alternatively, some application logic components of the event analysis system 30 can be hosted on the application server 16. The presentation module 32 communicates with the controller module 34, which in turn communicates with the data model module 36. Preferably, XML is used for data transfer between the presentation module and the data model module. The event analysis system 30 communicates with the CRM application 158 on the application server 16 via an application programming interface (API) to retrieve and save event data from and to the database 206. Alternatively, the event analysis system 30 may also communicate directly with the database and not require the CRM application 208. The CRM application 208 communicates with both the event classification module 204 and the database 206. Alternatively, the event analysis system 30 may also communicate directly with the event classification system 204.

The event analysis system 30 can be used to bring the following advantages to the clinical analysts who are target users of the event analysis system 30: efficient sequencing of event elements since a user is able to visually sequence, effective quality assessment and continuous quality improvement process since a user is able to visually assess and improve sequences and orders, error detection, a mechanism to transfer knowledge, and a simpler way to present the results of sequencing. The usability objective for the event analysis system 30 is to allow intuitive, effective, responsive user interactions. Advantageously, the event analysis system UI comprises the following qualities:

Intuitive—Minimizes the number of steps required to complete a task. Improves user interaction with actions such as “drag and drop”.

Continuity—Allows smooth progression through the stages of the sequencing process while keeping the user's focus.

Maintain the Big Picture—Allows the user to see all aspects of the application at the same time while keeping the user's focus on the coding panel area.

Control of Screen Real Estate—The screen area maximizes the coding panel area by having event element items listed in the new event elements panel and the deleted event element icons panel.

Responsiveness—Provides quick responses to user requests and actions.

The event analysis system 30 allows for the visual organization of event elements in an event. The organization of event elements can be used to analyse the event. Patterns can be searched in multiple events for more complex analysis. Thus, the event analysis system 30 and method (40, 120) can be used as an educational tool to reduce the chance of negative episodes from re-occurring. For example, a subset (or sub sequence) of event element icons 62 having relationships may be created in the coding panel 60. Then, a plurality of events stored in the database 206 may be traversed by a pattern recognition module to search for events having the created subset (or event pattern) of event element icons 62.

FIG. 11 shows in a flowchart one example of a method of event element pattern recognition (290), in accordance with an embodiment of the event analysis system 30. The method includes the step of translating a predetermined grouping of event elements into a pattern query (292). The pattern query may comprise a listing of event element types, in the progression of the event element pattern, with each event element type having associated variable values. Preferably, the pattern query is in structured query language (SQL). As the pattern recognition module traverses an event, the pattern recognition module performs a check (294) to see if there is a grouping of event element types that match the variable values of the created grouping of event element icons 62. An event having such event element patterns is then added to a result set (296) that can be used for targeted analysis. The method (290) is done (298). Other steps may be added to the method (290), including traversing a plurality of events in a repository. The event analysis system 30 is used in the above pattern recognition as a tool for creating an event element pattern, and as a tool for loading events into event element icons 62 to allow the pattern recognition module to search for the event element pattern.

Although various types of events may be analysed with the present invention, for ease of presentation, the remainder of this specification describes the invention as applied to clinical event analysis. One skilled in the art will appreciate details in the remaining examples that can be applied to non-clinical event analysis.

The event analysis system 30 and method (40, 120) can be used to assist clinical analysts in organizing clinical events that are stored in a database. Symbols may be created to represent clinical events. FIG. 12 shows examples of symbols associated with clinical events, in accordance with an embodiment of the event analysis system 30. These symbols can be implemented as icons in the coding panel 60. The event element symbols shown in FIG. 12 include presenting conditions 210 (PC), misdiagnosis 211 (MSD), comorbidities 212 (CMB), interventions 213 (INT), intervention delayed or not performed 214 (IDN), complications 215 (COM), patient clinical outcomes 216 (PCO), and critical incidents 217 (CI). Other symbols may be used for the event element types and other event element types may be defined.

Sequential coding enables root-cause analysis by capturing the relationships between the event element types and the involvement of all healthcare providers. Advantageously, the coding panel 60 is able, in a linear fashion, to address sequencing by attaching a number to ICD-10-CA/CCI and internal business codes.

The following is an example of a clinical event:

A patient is seen by her gynaecologist for complaints of dysmenorrhoea. After failed medical management, the patient was given the choice of surgical intervention. Patient underwent a hysterectomy, which was uneventful. Post-operatively, the patient complained of difficulty voiding. A bladder laceration was diagnosed and repaired by the urologist. The patient continued to complain of dysuria, and an antibiotic was prescribed. Two days after the operation, the patient complained of a rash. The Antibiotic was discontinued because the patient had a known allergy to the medication. An expert supported the surgeon's care, as a bladder laceration is an acceptable complication. However, the expert was critical of the urologist prescription of antibiotics in light of the patient's known allergy, which was clearly documented. The patient initiated legal proceedings that settled out of court.

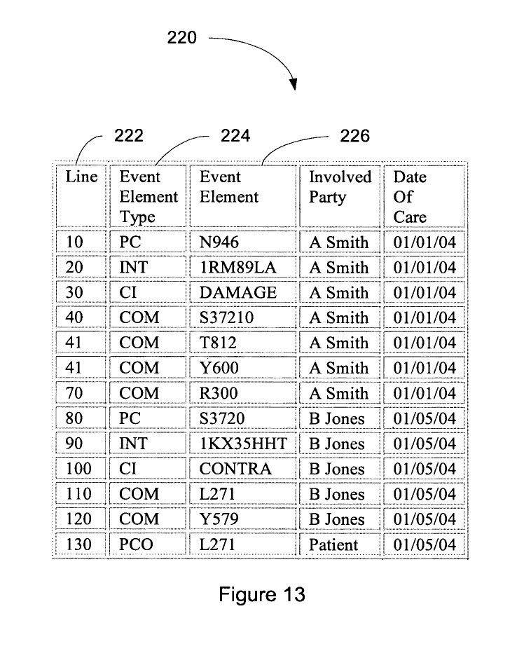

FIG. 13 shows an example of a medical information table 220 of a CRM application 208, in accordance with an embodiment of the event analysis system 30. The medical information table 220 includes a line number column 222, an event analysis type column 224, and an event analysis item column 226. Each row represents a different event element in the episode. The columns comprise data entries relating to some of the event elements in the example provided above. If a clinical analyst wishes to rearrange the rows, the clinical analyst would have to manually change the numbers in the line column 222. If events are listed incorrectly in the medical information table 220, it is onerous, if not impossible, for a medical analyst to sequence the event elements properly. Moreover, an analyst may not be able to determine sequences and orders of each event element to be able to analyse sub-episodes.

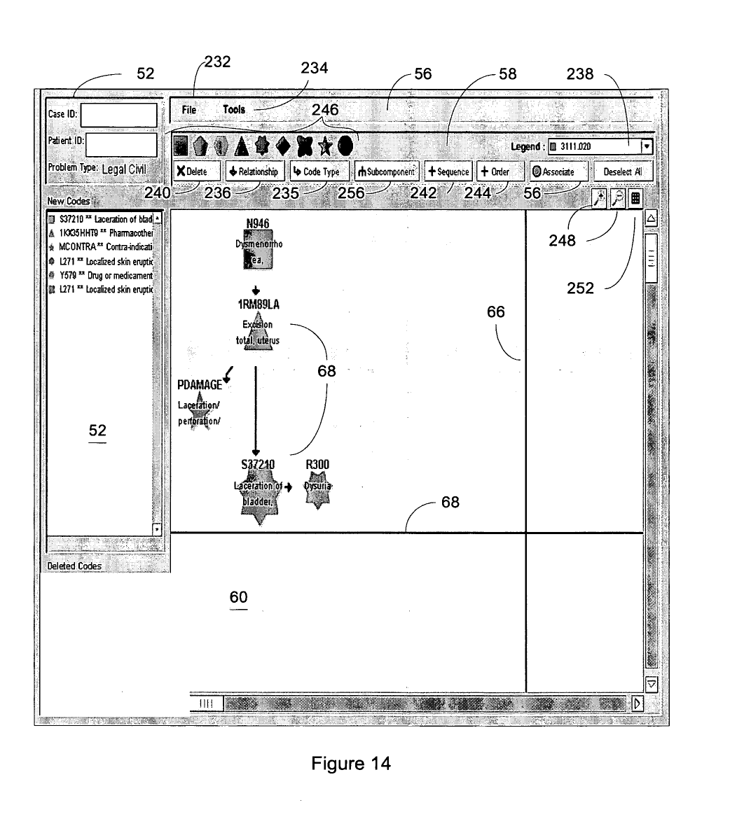

FIG. 14 shows in a screenshot an example of the UI of a presentation module 32, in accordance with an embodiment of the event analysis system 30. The example shows event element icons 62 in the new event elements panel 52 and event element icons 62 in the coding panel 60. The menu panel 56 shows a File menu and a Tools menu. The toolbar 58 shows different event element type symbols and buttons representing functions that a clinical analyst may use to modify the event element icons 62. The components of this example of a presentation module 32 include:

Identification Panel 50—This area of the window contains the case number, patient number and case problem type. Preferably, the patient is shown in bubble text if the user views the detailed information of an event element icon 62, as described below.

Menu Panel 56—The menu panel 56 is at the top of the event analysis system 30 presentation module 32 window. Preferably, the menu panel 56 contains a File menu 232 and a Tools menu 234.

File menu 232—A menu item in the File menu 232 is the Exit command.

Exit—The Exit command saves the sequencing result to a database and exits the event analysis system 30.

Tools menu 234—A menu item in the Tools menu 234 is the Export command.

Export—The Export command exports the graphical representation of the sequencing in XML format.

Toolbar Panel 58—The toolbar panel 58 is displayed at the top of the event analysis system 30 presentation module 32 window under the menu panel 56. The toolbar panel 58 provides command buttons for turning on/off the relationship mode, turning on/off the event element link mode, deleting event element links, deleting event element icons, changing the event element type of an event element icon and zooming in/out the coding panel 60.

Code type link button 235—A code type link is another type of event element link. A code type link button 237 is used for turning on or off the code type mode. When the relationship is on, it allows the user to add a code type link between two event element icons.

Relationship link button 236—A relationship link is one type of event element link. A relationship link button 236 is used for turning on or off the relationship mode. When the relationship mode is on, it allows the user to add a relationship link between two event element icons.

Delete button 240—A delete button 240 deletes the selected event element icon, or relationship link. The functionality of such a button may permit the deletion of order and sequence lines.

Add sequence button 242—An add sequence button 242 adds a new sequence line 68 below the existing grid. Preferably, by default the new sequence contains six rows when first launched. Preferably, newly added sequence lines 68 appear directly under the last event element icon 62.

Add order button 244—An add order button 244 adds a new order line 66 to the right of the existing grid. Preferably, by default the new order contains six columns. Preferably, newly added order lines 66 appear to the right of the last event element icon 62.

Event element type buttons 246—Event element type buttons 246 change the event element type (shape) of the selected event element icon.

Zoom in and zoom out buttons 248—Zoom in and zoom out buttons 248 allow the user to zoom in or zoom out the coding panel 60.

Associate function 250—Some event element icons 62 relate to participants which are not as directly involved in the analysis of the event as other participants. Sometimes, a sequence has a lone event element icon 62 of one participant among another participant's multiple event element icons 62. The associate function 240 may be used to associate the lone participant icon 62 to the preserve the placement of the lone participant icon 62.

Deselect All 252—If the user has selected multiple icons, links, order lines or sequence lines, clicking such a button 252 deselects all of them.

Grid On/Off 254—This shows the grid lines or hides them.

Subcomponent button 256—Such a button 256 is used to establish a subcomponent relationship between two event element icons 62.

Legend 258—This shows the involved party's colour code and is also used to select an involved party for the Associate function 250.

New Event Elements Panel 52—Event element icons 62 that have not been sequenced are displayed in an event element list in the new event elements panel 52. They can be dragged from the new event elements panel 52 to the coding panel 60 or to the deleted event elements panel 54.

Coding Panel 60—The coding panel 60 is the working area for organizing event element icons 62. The coding panel 60 displays the event element icons 62 that are being organized, and their relationships. Event element icons 62 can be dragged from the coding panel 60 to the new event elements panel 52 or to the deleted event element icons panel 54.

Deleted Event Element Icons Panel 54—Deleted event element icons are temporary stored in the deleted event element icons panel 54. An event element icon 62 can be restored from the deleted event element icons panel 54 by dragging it to the coding panel 60 or the new event elements panel 52. Typically, since the event element icon shapes change colour depending on the involved party, there is a legend indicating which colour belongs to which involved party.

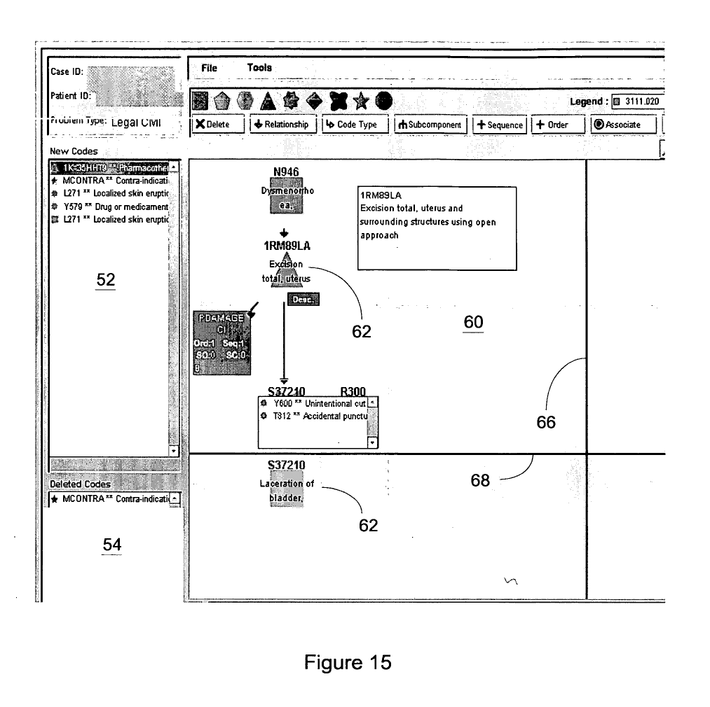

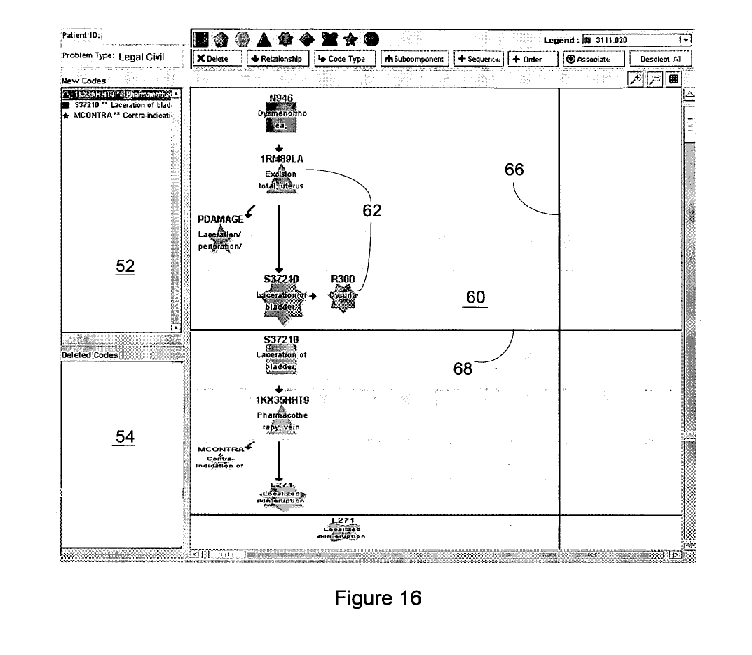

FIG. 15 shows in a screenshot the graphical representations of different types of relationships between event element icons 62 in this example, in accordance with an embodiment of the event analysis system 30. FIG. 16 shows in a screenshot the example of the UI of the event analysis system 30 after sequence coding is completed.

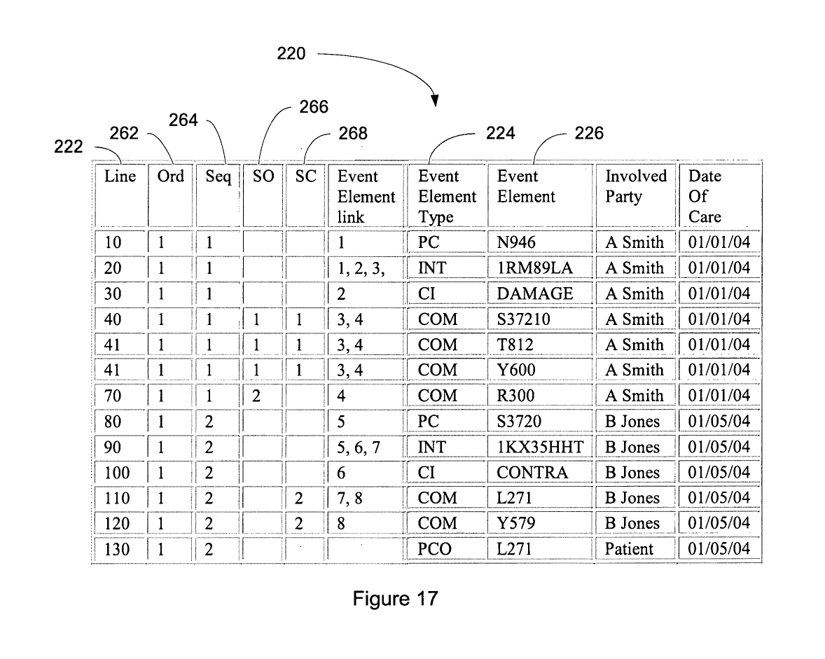

FIG. 17 shows in an example of the medical information table 220 of the CRM application 208 with the new event analysis information translated from the event element icons 62 of the event analysis system 30. New columns in this example include an order column 262, a sequence column 264, a suborder column 266, and a subcomponent column 268. Items updated or created by the event analysis system 30 include sequence 78, order 80, and suborder 82, event element link 84, subcomponent 86, event element type 88, and line number 222.

Analysts also have the possibility of deleting event element icons 62 from within the event analysis system 30. In this implementation, users do not have the ability to copy or add event element icons 62 while in the event analysis system 30 UI. Other implementations may allow this ability.

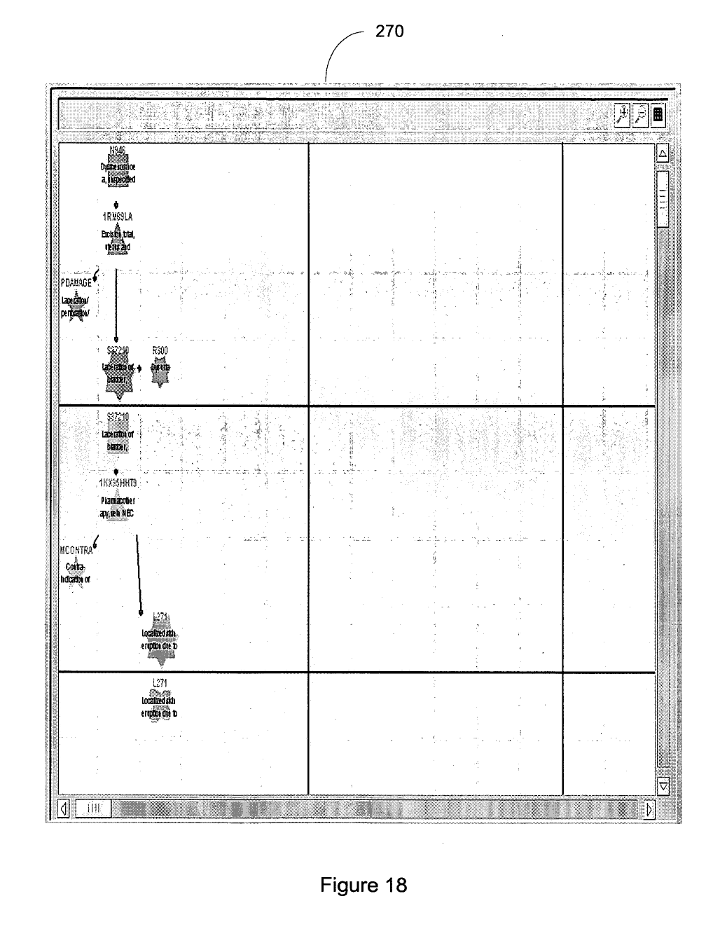

In one embodiment of the event analysis system 30, users have the option of exporting the graphical representation of the sequencing result in an XML format. When the user selects the Export command on the event analysis system UI, the event analysis system 30 translates the sequencing result in an XML document which can be packaged together with a viewer in a self-extracted archive executable file. The executable file can then be downloaded to the user's machine. Preferably, the event analysis system 30 viewer is a scaled-down version of the event analysis system 30 client. It allows the user to view the graphical presentation of the sequencing result with the zooming and scrolling capabilities available. The user invokes the event analysis system 30 viewer by double clicking on an executable file. FIG. 18 shows in a screenshot an example of a display of exported sequence coding information 270, in accordance with an embodiment of the event analysis system 30. Advantageously, the identifiers of participants are not included in the exported sequence coding information 270 to maintain confidentiality.

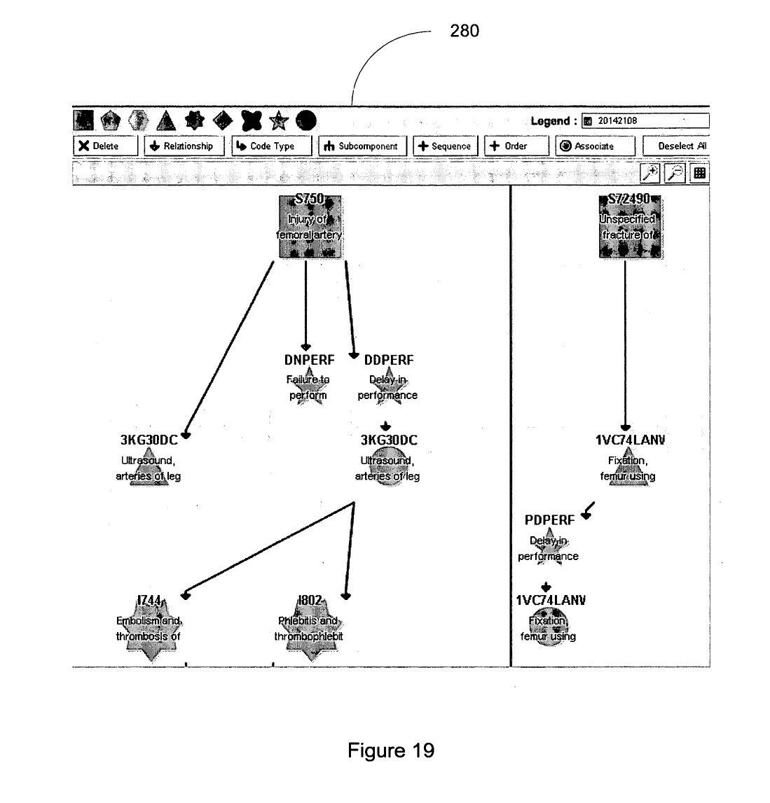

FIG. 19 shows in a screenshot an example of an event having two orders, in accordance with an embodiment of the event analysis system 30. In this example, a patient has two injuries as presenting conditions: 1. injury of femoral artery; and 2. unspecified fracture of the femur. By allowing an analyst to visually inspect the event elements 62, the analyst is able to easily distinguish between the first injury and the second injury.

The event analysis system 30 is used to visually sequence and order the event element icons 62 generated from an event classification module 204. The event analysis system 30 provides medical analysts with the ability to link presenting conditions 210, misdiagnoses 211, comorbidities 212, interventions 213, treatment delay 214, complications 215, patient clinical outcomes 216, and critical incidents 217 in a “cause and effect” fashion by sequencing, ordering and relating the clinical facts of a clinical event. Medical analysts may visually link the event element types in the “cause and effect” fashion by transferring their assessment of the germane facts and order the clinical facts appropriately with the assistance of a pointing tool such as a mouse. Advantageously, complications may be linked in succession, showing the resulting complications that followed a prior complication.

The event analysis system 30 provides many benefits. One such benefit includes the fact that the event analysis system 30 graphically illustrates the chain of event elements in a care episode thereby helping the medical analyst verify the sequencing. A second benefit includes the fact that the event analysis system 30 can be used as an educational tool to illustrate patterns in clinical care.

Advantageously, the event analysis system 30 provides an efficient/user friendly sequencing process for medical analysts. The event analysis system 30 also provides an efficient quality assessment and continuous quality improvement process. Furthermore, the event analysis system 30 provides an efficient knowledge transfer and improved understanding of root-cause event elements. Moreover, the event analysis system 30 provides value to presentations and produces measurable risk prevention/mitigation. Another advantage is that the event analysis system 30 assists with improved error detection from visual representation.

The systems according to the present invention, and the methods described above, may be implemented by any hardware, software or a combination of hardware and software having the functions described above. The software code, either in its entirety or a part thereof, may be stored in a computer readable memory. Further, a computer data signal representing the software code that may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention.

What is claimed is:

1. A method of analysing events, the method comprising the steps of:
displaying event element icons in a user interface, the event element icons representing event elements in an event, the event element icons movable in a coding panel of the user interface;
updating the location of moved event element icons in the user interface; and
determining an organization of event elements based upon the location of the event element icons in the user interface.

2. The method as claimed in claim 1, wherein the step of determining an organization includes the step of determining sequences of the event element icons based upon the location of the event element icons in the user interface.

3. The method as claimed in claim 1, wherein the step of determining an organization includes the step of determining orders of the event element icons based upon the location of the event element icons in the user interface.

4. The method as claimed in claim 1, further comprising the step of assigning visual features to the event element icons to distinguish different types of the event element icons.

5. The method as claimed in claim 4, wherein the step of assigning includes the steps of:
assigning different shapes to distinguish between different types of the events elements;
assigning different colours to distinguish between different participants in the events; and
assigning different sizes to distinguish between single event elements and a plurality of event elements grouped together.

6. The method as claimed in claim 5, wherein the step of assigning different colours further includes the step of assigning secondary colours to distinguish different memberships of the participants.

7. The method as claimed in claim 6, wherein the step of assigning different shapes further includes the step of assigning tertiary colours to preserve the placing of an event element icon in the visual display.

8. The method as claimed in claim 1, further comprising the steps of:
translating a predetermined grouping of event element icons into a pattern query;
determining the presence of the pattern in an event; and
updating a result set with an event having the pattern.

9. The method as claimed in claim 8, further comprising the steps of traversing a plurality of events in a repository.

10. The method as claimed in claim 1, further comprising the steps of:
analysing a chain of event elements to generate event element item data;
translating the event element item data into event element icons to graphically represent the event elements;
updating the event element item data based upon the location of the event element icons in the user interface; and
storing the event element item data in a repository.

11. The method as claimed in claim 10, further comprising the steps of:
generating the user interface;
retrieving the event element item data from the repository; and
processing the event element icons based upon the event element item data.

12. The method as claimed in claim 1, further comprising the steps of:
extracting clinical event information from a repository;
transforming the clinical event information into a data model;
loading the clinical event information into one or more data structure items in a coding panel of the user interface; and
exporting an organization of the clinical event information to a data analysis system.

13. An event analysis system for analysing events, the event analysis system comprising:
a presentation module for generating a user interface and event element icons for the user interface, the event element icons representing event elements in an event;
a controller module for controlling the display of the user interface and updating the data structure representing the event elements; and
a data model module for holding the data structure and used to generate the event element icons.

14. The event analysis system as claimed in claim 13, wherein the event element icons have visual features distinguish different types of event element icons.

15. The event analysis system as claimed in claim 14, wherein the event element icons have:
different shapes to distinguish between different event element types;
different colours to distinguish between different event participants; and
different sizes to distinguish between single event elements and a plurality of event elements grouped together.

16. The event analysis system as claimed in claim 15, wherein the event element icons further have different secondary colours to distinguish between different memberships of the participants.

17. The event analysis system as claimed in claim 13, wherein the user interface includes a coding panel for displaying the event element icons, the event element icons movable in the coding panel with each event element icons updating their location in the coding panel.

18. The event analysis system as claimed in claim 17, wherein the coding panel includes a grid structure having horizontal and vertical coordinates.

19. The event analysis system as claimed in claim 18, wherein the coding panel further includes:
one or more event element icons;
one or more order line elements for graphically representing order boundaries; and
one or more sequence line elements for graphically representing sequence boundaries.

20. The event analysis system as claimed in claim 19, wherein the coding panel further includes one or more link elements for graphically representing links between event element icons.

21. The event analysis system as claimed in claim 13, wherein the data structure includes:
event analysis data for representing the event elements, including event sequence information; and
graphical representation data for use in the presentation module.

22. The event analysis system as claimed in claim 21, wherein the event analysis data includes:
an event element identifier;
a line number component for representing the position of the event element;
a sequence component for representing a sequence value in the coding panel;
an order component for representing an order value in the coding panel;
a suborder component for representing a suborder value in the coding panel;
an event element link component for representing a suborder link value in the coding panel;
a subcomponent component for representing a subcomponent value in the coding panel;
an event element type component for representing a type of event element;
a participant type component for denoting the type of participant in the event element; and
a description field for describing the event element.

23. The event analysis system as claimed in claim 21, wherein the graphical representation data includes:
an event icon identifier;
attributes representing x and y coordinates;
an attribute representing a parent relationship between event element icons;
an element link structure for graphically representing a link between event element icons, the link structure having link type, source, and destination event element icons; and
a boundary structure for graphically representing sequence and order lines in a grid of the coding panel, the boundary structure having sequence definitions and order definitions.

24. The event analysis system as claimed in claim 17, further comprising:
a repository for storing event analysis data, the event analysis data loadable into the data model module;
a new event element icons panel for holding event element icons generated from the data model module;
an identification panel for holding identification information for the event;
a deleted event element icons panel for temporarily holding event element icons removed from the coding panel or the new event icons panel;
a menu panel for holding user interface options; and
a toolbar panel for holding event element icons manipulation tools.

25. The event analysis system as claimed in claim 17, further comprising:
a repository for storing clinical event information, the presentation module receiving clinical event information from the repository, the repository including a data file for storing the data structure;
event classification means for finding the event element item data for a clinical event;
an application server running a customer resource management application for accessing the repository and encoder;
a web server for running event analysis system software to communicate with the customer resource management application; and
a web browser for running a client application of the event analysis system and for communicating with the web server, the web browser including a viewer for exporting a sequence and an order of the clinical event information based upon the location of the event element icons in the coding panel.

26. The event analysis system as claimed in claim 25, wherein the event classification means is a link to an event classification module that is external to the event analysis system.

27. The event analysis system as claimed in claim 13, further comprising a pattern recognition module for determining if an event includes a predetermined pattern query.

28. A computer data signal embodied in a carrier wave and representing sequences of instructions which, when executed by a processor, cause the processor to perform a method of analysing events, the method comprising the steps of:
displaying event element icons in a user interface, the event element icons representing event elements in an event, the event element icons movable in a coding panel of the user interface;
updating the location of moved event element icons in the user interface; and
determining an organization of the event elements based upon the location of the event element icons in the user interface.

29. A computer-readable medium having computer readable code embodied therein for use in the execution in a computer of a method of analysing events, the method comprising the steps of:
displaying event element icons in a user interface, the event element icons representing event elements in an event, the event element icons movable in a coding panel of the user interface;
updating the location of moved event element icons in the user interface; and
determining an organization of the event elements based upon the location of the event element icons in the user interface.

30. A computer program product for use in the execution in a computer of an event analysis system for analysing events, the computer program product comprising:
a presentation module for generating a user interface and event element icons for the user interface, the event element icons representing event elements in an event;
a controller module for controlling the display of the user interface and updating the data structure representing the event elements; and
a data model module for holding the data structure and used to generate the event element icons.
